(19) United States
(12) Patent Application Publication
(10) Pub. No.: US 2025/0078030 A1
(43) Pub. Date: Mar. 6, 2025

(54) METHOD AND SYSTEM FOR CROWD SOURCING IN AN ACADEMIC ENVIRONMENT

(71) Applicant: D2L Corporation, Kitchener (CA)

(72) Inventor: Jeremy AUGER, Kitchener (CA)

(21) Appl. No.: 18/821,158

(22) Filed: Aug. 30, 2024

Related U.S. Application Data
(60) Provisional application No. 63/580,163, filed on Sep. 1, 2023.

(51) Int. Cl. G06Q 10/101; G06Q 50/20

(52) U.S. Cl. CPC G06Q 10/101; G06Q 50/20

(57) ABSTRACT

A method and system for crowd sourcing a project. The method includes: receiving information about crowd source targets from one or more streams; determining a plurality of crowd source targets based on the information; ranking the plurality of crowd source targets based on the information; contacting the plurality of crowd source targets in relation to the project based on the ranking; and monitoring responses from the plurality of crowd source targets and aggregating responses. The system includes: a memory for storing computer-executable instructions; a processor configured to implement the computer-executable instructions to provide: an input module to receive information about crowd source targets from one or more streams; and a crowd source module to: determine crowd source targets based on the information; rank the targets based on the information; contact the targets based on the ranking; and monitor responses from the targets and aggregate responses.

### FIELD

The present disclosure relates generally to online computer technology and learning management systems. More particularly, the present disclosure relates to a method and system for crowd sourcing in an academic environment using a learning management system.

### BACKGROUND

Generally speaking, crowd sourcing uses a network such as the Internet to obtain information, funds, or the like from a variety of sources in a distributed manner. Crowd sourcing has become a viable solution to collect information, funds, or the like from a large group of people in a relatively short time and in an efficient manner. Crowd sourcing is frequently used to develop ideas, perform tasks or in financial situations.

Crowd sourcing has most typically been used for gathering funding but can also be used for information gathering, task management, and the like. As crowd sourcing continues to develop, there will be a need for more flexible crowd sourcing options that can also deal with data privacy and related issues that can arise when groups of people are involved. As such, there is a need for an improved system and method for crowd sourcing.

The above information is presented as background information only to assist with an understanding of the present disclosure. No determination has been made, and no assertion is made, as to whether any of the above might be applicable as prior art with regard to the present disclosure.

### SUMMARY

In a first aspect, there is provided a method for crowdsourcing a project including: receiving a plurality of crowdsource targets from one or more streams; ranking the plurality of crowdsource targets based on the streams; contacting the plurality of crowdsource targets in relation to the project based on the ranking; monitoring the plurality of crowdsource targets for participation; and monitoring the one or more streams and plurality of crowdsource targets for feedback.

According to another aspect herein, there is provided a method for crowd sourcing a project including: receiving information about crowd source targets from one or more streams; determining a plurality of crowd source targets based on the information; ranking the plurality of crowd source targets based on the information; contacting the plurality of crowd source targets in relation to the project based on the ranking; and monitoring responses from the plurality of crowd source targets and aggregating responses.

In some cases, the method further includes monitoring the one or more streams and plurality of crowdsource targets for input/feedback.

In some cases, the receiving information may include using an AI tool to aggregate information.

In some cases, the determining a plurality of crowd source targets may include using an AI tool to analyze the information.

In some cases, the contacting the plurality of crowd source targets may include providing specific options for responding to the contact.

In some cases, the project may include determining a course stream in a learning management system.

In some cases, the project may include providing pre-requisites for a course in a learning management system.

According to another aspect herein, there is provided a system for crowd sourcing a project, the system including: a memory for storing computer-executable instructions; a processor configured to implement the computer-executable instructions to provide: an input module configured to: receive information about crowd source targets from one or more streams; and a crowd source module configured to: determine a plurality of crowd source targets based on the information; rank the plurality of crowd source targets based on the information; contact the plurality of crowd source targets in relation to the project based on the ranking; and monitor responses from the plurality of crowd source targets and aggregate responses.

In some cases, the crowd source module may be further configured to monitor the one or more streams and plurality of crowdsource targets for input/feedback.

In some cases, the input module may be further configured to receive information using an AI tool to aggregate information.

In some cases, the crowd source module may be further configured to determine a plurality of crowd source targets may include using an AI tool to analyze the information.

In some cases, the crowd source module may be further configured to the contact the plurality of crowd source targets including providing specific options for responding to the contact.

In some cases, the project may include determining a course stream in a learning management system.

In some cases, the project may include providing pre-requisites for a course in a learning management system.

Other aspects and features of the present disclosure will become apparent to those ordinarily skilled in the art upon review of the following description of specific embodiments in conjunction with the accompanying figures.

### BRIEF DESCRIPTION OF FIGURES

Embodiments of the present disclosure will now be described, by way of example only, with reference to the attached Figures.

FIG. 1 illustrates an example of a learning management system;

FIG. 2 illustrates a system for crowd sourcing according to an embodiment;

FIG. 3 is a flowchart illustrating a method for crowd sourcing according to an embodiment; and

FIG. 4 illustrates an example of various inputs for the system and method for crowd sourcing.

### DETAILED DESCRIPTION

The following description with reference to the accompanying drawings is provided to assist in a comprehensive understanding of example embodiments as defined by the claims and their equivalents. The following description includes various specific details to assist in that understanding but these are to be regarded as merely examples. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not intended to be limited to the bibliographical meanings but are merely used by the inventor to enable a clear and consistent understanding. Accordingly, it should be apparent to those skilled in the art that the following description of embodiments is provided for illustration purpose only and not for the purpose of limiting the invention as defined by the appended claims and their equivalents.

Generally, the present disclosure provides a method and system for crowd sourcing for learning management systems, corporate environments, or the like. In particular, the embodiments of the system and method detailed herein provide for an ability to crowdsource payment of fees in a flexible manner and/or providing data with respect to meeting various requirements. Generally speaking, embodiments of the method and system herein are intended to control user access to private data and allow flexibility in a crowd sourcing system.

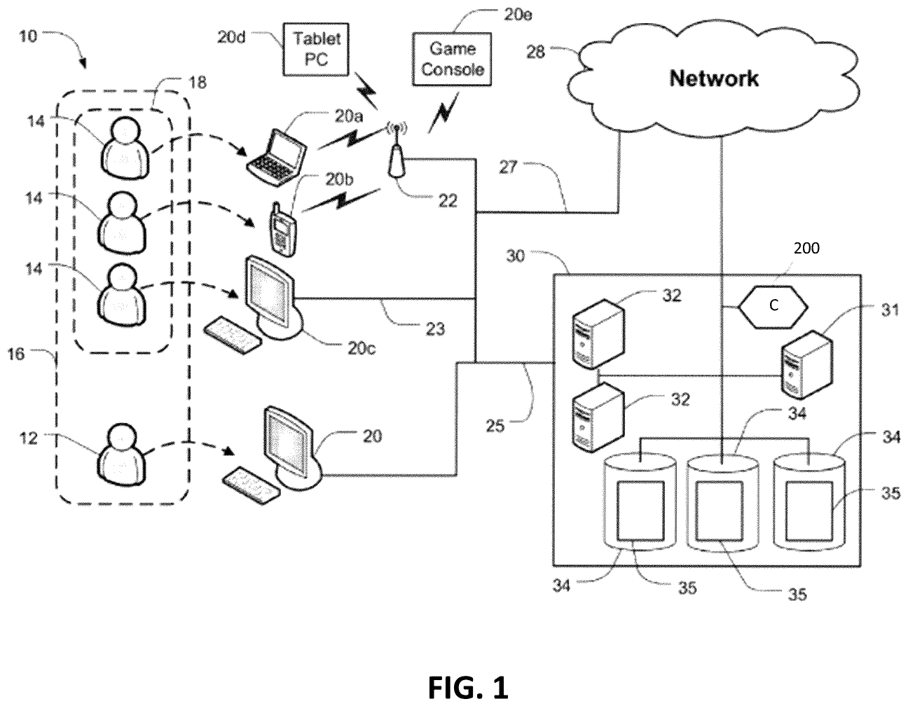

FIG. 1 illustrates an example embodiment of a learning management system 10 according to one embodiment. The learning management system 10 includes an educational service provider system 30, which can be accessed electronically by various users 12, 14.

The users 12, 14 communicate with the educational service provider system 30 either directly or indirectly using any suitable computing device 20, such as, a computer that has at least one input device (for example, a keyboard, a mouse, or the like) and at least one output device (for example, a display screen, speakers, or the like). Other examples of the computing device may include: a laptop 20a wirelessly coupled to an access point 22 (for example, a wireless router, a cellular communications tower, or the like), a wirelessly enabled mobile device, smart phone or the like 20b, a terminal 20c over a wired connection 23, a tablet computer 20d, or a game console 20e over a wireless connection. The computing devices 20 may be connected to the educational service provider system 30 via any suitable communications channel. For example, the computing devices 20 may communicate to the educational service provider system 30 directly through a LAN/intranet or wireless network via a data connection 25, or using an external network, such as, for example, the Internet 28 over a data connection 27.

In some cases, one or more of the users 12 and 14 may be required to authenticate their identities in order to communicate with the educational service provider system 30. For example, the users 12 and 14 may be required to input a login name and/or a password or otherwise identify themselves to gain access to the learning management system 10. In other cases, one or more users (e.g., “guest” users) may be able to access the learning management system 10 without authentication. Such guest users may be provided with limited access, such as the ability to review only one or a few components of the course, for example, to decide whether they would like to enroll in a particular course.

The educational service provider system 30 generally includes a number of components for facilitating the provision of electronic learning services. For example, the educational service provider system 30 generally includes one or more processing devices 32 (e.g., servers), each having one or more processors. The processing devices 32 are configured to send information to be displayed on one or more computing devices 20, 20a, 20b and/or 20c in association with electronic learning (or other like information).

The educational service provider system 30 also generally includes one or more data storage devices 34 (sometimes referred to as memory) that are in communication with the processing devices 32 and could include a relational database (such as an SQL database), or other suitable data storage devices. The data storage devices 34 are configured to host data 35 about the courses, programs and other information associated with the service provider.

For example, the data 35 can include course frameworks, educational materials, costs and fees associated with each of the users 14, historical records about assessments or grades of users 14 or assignments completed by the users 14, as well as other information.

The data storage devices 34 may also store authorization criteria that define which actions may be taken by the users 12 and 14. In some cases, the authorization criteria may include at least one security profile associated with at least one role. For example, one role could be defined for users who are primarily responsible for developing an educational course, teaching it, and assessing work product from students of the course. Users with such a role may have a security profile that allows them to configure various components of the course, to post assignments, to add assessments, to evaluate performance, and so on.

In some cases, some of the authorization criteria may be defined by specific users who may or may not be part of the educational community 16. For example, users may be permitted to administer and/or define global configuration profiles for the learning management system 10, define roles within the learning management system 10, set security profiles associated with the roles, and assign roles to particular users 12 and 14 who use the learning management system 10. In some cases, the users may use another computing device to accomplish these tasks.

The data storage devices 34 may also be configured to store other information, such as personal information about the users 12 and 14 of the learning management system 10, information about which courses the users 14 are enrolled in, roles to which the users 12 and 14 are assigned, particular interests of the users 12 and 14, and historical information about the performance of the users 12 and 14.

The processing devices 32 and data storage devices 34 may also provide other electronic learning management tools (e.g., allowing users to add and drop courses, communicate with other users using chat software, pay fees, and the like), and/or may be in communication with one or more other vendors that provide the tools.

It will be understood that computing devices generally include a processor, a memory, a communication apparatus (for network connection or the like), an output device such as a display, speakers or the like, and an input device such as a touch screen, keyboard or the like. A user 12, 14, uses the functions of the computing device to communicate with the educational service provider system 30 as described herein.

Generally speaking, the users 12, 14 can use the learning management system 10 to communicate with the educational service provider system 30 to participate in, create, and consume electronic learning services, including enrolling in and participating in various educational courses. In some cases, the educational service provider system 30 may be part of or associated with a traditional “bricks and mortar” educational institution (e.g., an elementary school, a high school, a university or a college), another entity that provides educational services (e.g., an online university, a company that specializes in offering training courses, or an organization that has a training department), or an independent service provider (e.g., for providing individual electronic learning). Further, it will be understood that a corporation may have s similar set up with a personal Virtual Private Network or similar internal networking structure.

It is noted that a “course” is not necessarily limited to formal courses offered by formal educational institutions. The course may generally include any form of learning instruction offered by an entity of any type. For example, the course may be a training seminar at a company for a small group of employees, a professional certification program with a larger number of intended participants (e.g., PMP, CMA, etc.), and so on.

It should be understood that users 12, 14 may fall into various categories, including students, instructors, guests, or the like. Further, one or more educational groups can be defined that involve one or more of the users 12 and 14. For example, as shown in FIG. 1, the users 12, 14 may be grouped together in an educational group 16 representative of a particular course, in which the first user 12 is an “instructor” and is responsible for providing the course (e.g., organizing lectures, preparing assignments, creating educational content, etc.), while the other users 14 are “learners” or “students” that consume the course content. In some cases, the users 12 and 14 may be associated with more than one educational group. For instance, the users 14 may be enrolled in more than one course, while the user 12 may be enrolled in a course and also responsible for teaching a different course.

In some cases, educational sub-groups may also be defined. For example, in FIG. 1, some users 14 are shown as part of an educational sub-group 18. The sub-group 18 may be defined in relation to a particular project or assignment (e.g., sub-group 18 may be a lab group) or based on other criteria. In some cases, due to the nature of electronic learning, the users 14 in a particular sub-group 18 need not physically meet but may collaborate together using various tools provided by the educational service provider system 30.

In some cases, the groups 16 and sub-groups 18 could include users 12 and 14 that share common interests (e.g., interests in a particular sport), that participate in common activities (e.g., users that are members of a choir or a club), and/or have similar attributes (e.g. users that are male, users under twenty-one years of age, etc.).

The educational service provider system 30 can also include a crowd sourcing system 200 as described further herein.

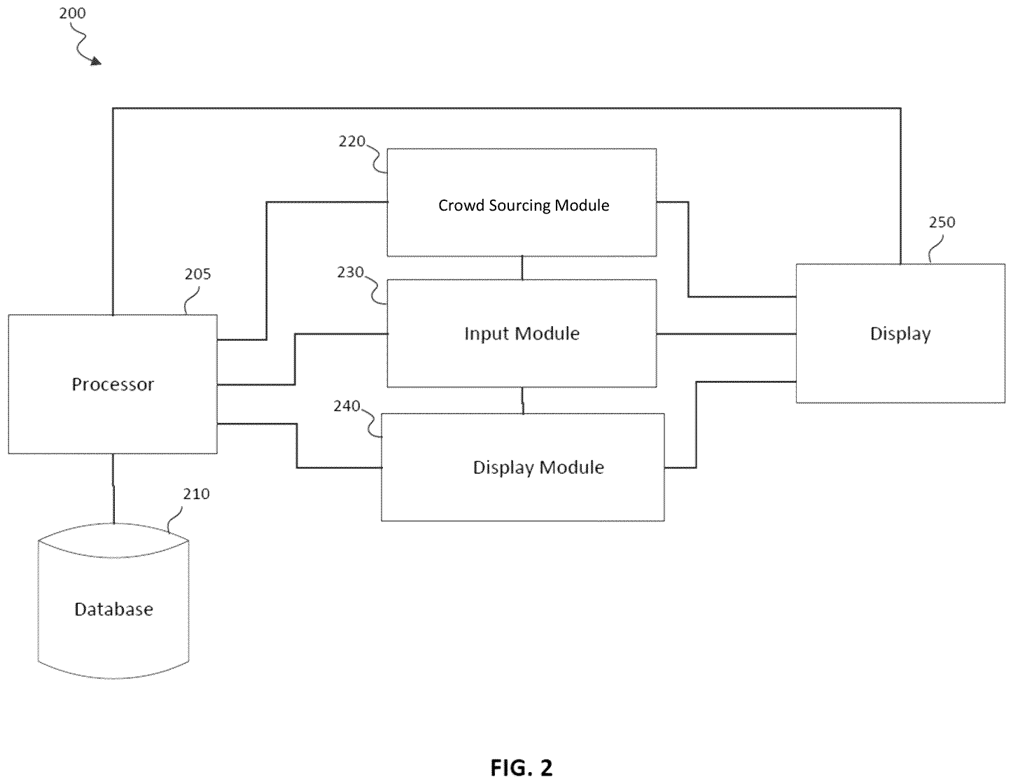

FIG. 2 illustrates an embodiment of the crowd sourcing system 200. The system 200 includes a processor 205, a memory/database 210 operatively connected with the processor 205, a crowd sourcing module 220, an input module 230, a display module 240 and, optionally, a display 250. In some cases, the crowd sourcing system 200 may be separate from the educational service provider system 30 or the learning management system 10.

The processor 205 is configured to operatively connect with and execute the instructions of the modules 220, 230, 240 and provide instructions/control the display 250. In some cases, each module may include a separate processor. In other cases, the system 200 may be a component within an electronic device, and the processor 205 may be a central processing unit for the electronic device. The electronic device may be network-enabled such that system 200 or the processor 205 communicates with a network.

Generally speaking, the processor 205 is configured to interact with the database 210. The database 210 may generally be any electronic storage medium known in the art. In some cases, the database 210 may be a component of one of the modules. In other cases, the database 210 may be an operable combination of two or more databases or may be a part of another systems such as the educational service provider system 30. The database 210 may be automatically managed, managed by one or more users, managed by one or more administrators, or the like.

The database 210 is configured to store data, the data may be associated with a crowd sourcing program. In some cases, the database 210 may also store the organization or structure associated with the user commencing the crowd sourcing and other users within and/or outside the organization (for example, a learning management system, a corporate system, or the like). In other cases, the data pertaining to the organization or crowd sourcing program can be computed by the processor 205 or input via the input module 230.

The crowd sourcing module 220 is configured to determine a crowd sourcing program and associated data with the crowd sourcing program. In some cases, the associated data may be retrieved from, for example, the input module which has received the data from a user or from a separate system, such as a learning management system. The crowd sourcing module 220 may further be configured to query the database or memory component to retrieve data associated with the crowd sourcing program.

The input module 230 monitors for input received from a user of the system or from external systems. The input module 230 is configured to gather the input in order to determine a breakdown or division of the input with respect to possible crowd sourcing. In some cases, the input module may receive input from a student of the learning management system. In other cases, the input may be received from an administrator or other third party source.

The display module 240 is configured to receive the crowd source data from the crowd source module and determine a manner in which to display the data to an associated audience. The display module 240 may determine whether all users may access the crowd sourcing data in question or if a subset of users or third parties may have access to the crowd source data. Further the display module can be operatively connected with the user's display 250 where the appropriate data is physically displayed as detailed herein.

In a specific example, the system and method for crowd sourcing may be used to enable the payments of fees by a student associated with the learning management system 10. The student may provide input as to people of the student's choosing that may receive a payment link with respect to the outstanding student fees. Each recipient may then provide payment of a portion of the outstanding fees. In some cases, the student may predefine how the payment is to be split amongst the recipients. In other cases, the recipients may provide payment anywhere from a predetermined minimum threshold, for example, $1, $5, $10 or the like, to the full required amount. Further, in some cases, there may be predetermined contribution amounts, for example, increments of $1, $5, $10 or the like that could be selected by a recipient associated with the student. In some cases, the system may gather and provide input that may not be input by the student, for example, other sources from which a student may receive payment, for example, government funding, employers, or the like, and the system may be able to include contact with these entities and/or these payments as part of the crowd sourcing program.

Embodiments of the system and method can also be used beyond the crowdsourcing of fees and payments in a learning management system. In some cases, the system may be used to crowd source pre-requisites, recommendation letters, showing or learning of skills, choosing courses or a course stream, or the like in a learning management system. For example, in some cases, embodiments may allow for a student or employee within an organization to contact a plurality of recipients to request a recommendation from various previous employers. In another specific example, a user may provide a video of them practicing a skill that is the basis for a prerequisite, or a similar situation.

Embodiments of the system can be further configured to review the input and determine whether there are further sources/streams of payment or input that can be used, such as, in relation to funding, scholarships, grants from various sources (government, corporate, etc.), or the like.

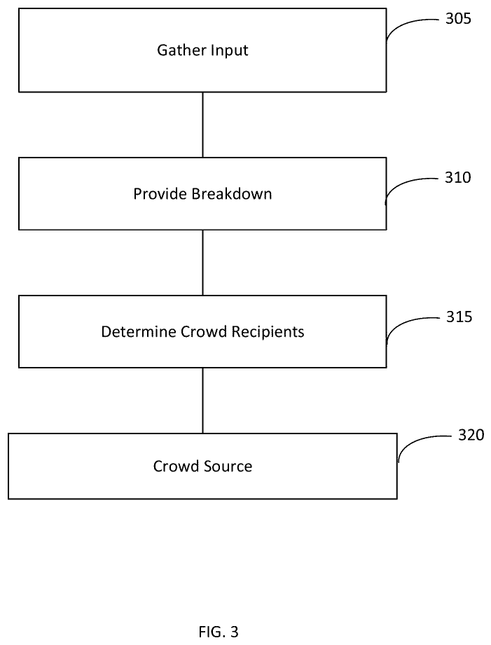

FIG. 3 is a flowchart illustrating a method 300 for crowdsourcing according to an embodiment.

At 305, input is gathered based on a crowd sourcing goal/project. In some cases, the input may be received from the user of the system, which is one type of stream, sometimes referred to as a user stream. In other cases, the input module may query third party systems in order to receive crowd sourcing input from one or more streams. Streams may include information from other servers, the Internet, or the like and may be found or interpreted by artificial intelligence (AI), machine learning, or other tools. The input generally provides for a plurality of crowd source targets, which are individuals, organizations, websites, or the like that can be used for achieving the crowd sourcing goal.

At 310, the crowd sourcing module determines an appropriate breakdown or ranking of the crowd sourcing data input and/or targets. In some cases, the breakdown/ranking may be in reference to a student tuition or other payment while in other cases the breakdown/ranking may be in reference to recommendations, pre-requisites, or other non-monetary items to be crowd sourced. The input module may provide sources that may be contacted for payment or other input including, for example, relatives, employers, schools, government, employers, and the like. In some cases, an initial input/data, such as, for example, the amount of government funds already committed, may be determined first in order to determine remaining input/amounts that may be required. In other cases, other hierarchies of crowd sourcing data may be used, for example, one or more past schools may be contacted to determine if a current student has previously attended an appropriate prerequisite class.

At 315, specific crowd source targets/recipients from the crowd sourcing input data may be determined. In a case where all targets are to receive the crowd sourcing request, this may be optional. For example, a user may be provided with this as an option. As noted, the targets/recipients may be various people within and/or outside of an organization, organizations themselves, websites, or the like that are able to provide data, payment, or the like related to the crowd sourcing goal.

At 320, the crowd sourcing activity takes place. That is, the crowd source targets/recipients are contacted about the crowd sourcing goal, generally including options for assisting with the goal (for example, a link to a website or the like). The targets/recipients can then are monitored for a response indicating some form of participation or opting out. In some cases, the targets/recipients may be provided reminders if there is no response. If the targets/recipients respond, it will include the the data, payment, other requirements or the like that were requested via the crowd sourcing system. The crowd sourcing system can then consolidate/allocate the input/money to an appropriate goal, for example, a payment or prerequisite if the data received is a payment or prerequisite information within a learning management system.

In some cases, the method may also include monitoring the one or more streams and/or plurality of crowdsource targets for input/feedback in relation to the crowd sourcing goal and/or result. This feedback can be used for future crowd sourcing projects/goals as well as with regard to ranking the particular streams.

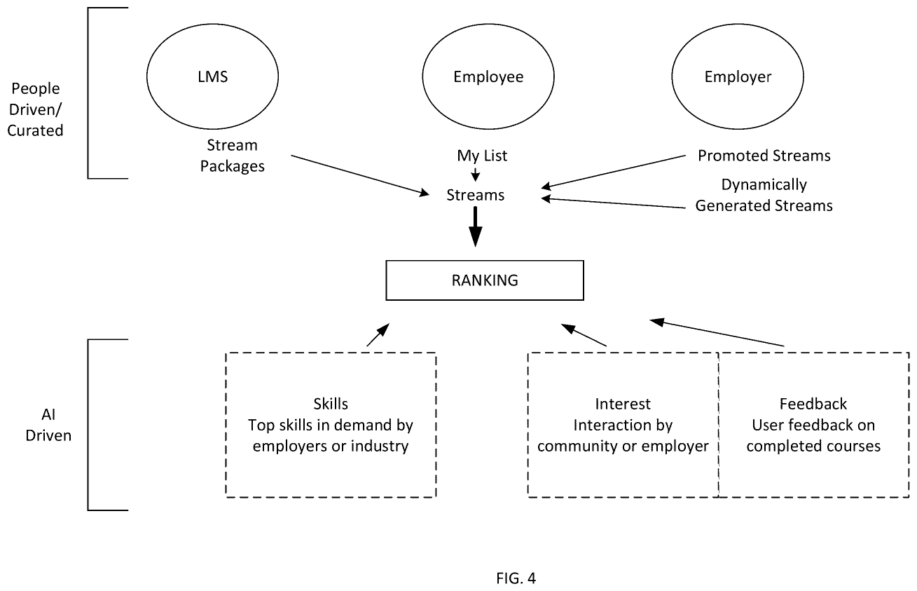

FIG. 4 illustrates an example of various inputs that may be used in by the system and method in determining targets/recipients or ranking of information/targets for the crowd sourcing system. The input module is intended to receive people driven or curated services or streams from predetermined third party sources, employees, corporations, users or the like. In an example associated with a learning management system the input module may receive data associated with predetermined a course stream package or packages. The crowd sourcing module may provide for ranking or a breakdown of the course streams after receiving input from the stream packages offered by the learning institution, the streams a specific user has shown interest to, and the streams other users have promoted or otherwise reviewed and provided further crowd sourced data. In some cases, the system may further review a user's skills, interest and previous feedback to generate rankings associated with particular streams.

For example, the user may wish to determine which course streams the user wishes to enlist into in an upcoming term and wishes to have crowd sourced data in review of this decision. The system may receive crowd sourced data with respect to other users and the learning management system on various available streams. The user may also choose to rank, or have ranked, certain courses or options as input. Further, the system may review other networked devices and online interactions to provide crowd sourced data with respect to the courses and streams. In some cases, the system may review student feedback or completed courses and associated marks and opinions on the course to amend a ranking for the user. Further, the system may review interactions of the user with the community, school, employer, and the like, to provide feedback with respect to the streams. It is intended that this crowd sourced data may be retrieved and reviewed and used in ranking of the potential course streams. Further, the system may review the user's skills and skills in demand by an employer and/or industry and associate these skills with the various streams and courses offered to amend the ranking for the user. In some cases, the review of various information streams may be assisted with AI, machine learning, or related tools. In this case, these streams may be described as AI driven. With this various crowd sourced input, the system is intended to provide the user with a ranking or breakdown of the courses streams/packages that may be preferable or more beneficial to the user.

In the preceding description, for purposes of explanation, numerous details are set forth in order to provide a thorough understanding of the embodiments. However, it will be apparent to one skilled in the art that these specific details may not be required. In other instances, structures may be shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. A method for crowd sourcing a project comprising:
receiving information about crowd source targets from one or more streams;
determining a plurality of crowd source targets based on the information;
ranking the plurality of crowd source targets based on the information;
contacting the plurality of crowd source targets in relation to the project based on the ranking; and
monitoring responses from the plurality of crowd source targets and aggregating responses.

2. A method for crowdsourcing a project according to claim 1, the method further comprising monitoring the one or more streams and plurality of crowdsource targets for input/feedback.

3. A method for crowdsourcing a project according to claim 1, wherein the receiving information comprises using an AI tool to aggregate information.

4. A method for crowdsourcing a project according to claim 1, wherein the determining a plurality of crowd source targets comprises using an AI tool to analyze the information.

5. A method for crowdsourcing a project according to claim 1, wherein the contacting the plurality of crowd source targets comprises providing specific options for responding to the contact.

6. A method for crowdsourcing a project according to claim 1, wherein the project comprises determining a course stream in a learning management system.

7. A method for crowdsourcing a project according to claim 1, wherein the project comprises providing pre-requisites for a course in a learning management system.

8. A system for crowd sourcing a project comprising:
a memory for storing computer-executable instructions;
a processor configured to implement the computer-executable instructions to provide:
an input module configured to:
receive information about crowd source targets from one or more streams;
a crowd source module configured to:
determine a plurality of crowd source targets based on the information;
rank the plurality of crowd source targets based on the information;
contact the plurality of crowd source targets in relation to the project based on the ranking; and
monitor responses from the plurality of crowd source targets and aggregate responses.

9. A system for crowdsourcing a project according to claim 8, the crowd source module is further configured to monitor the one or more streams and plurality of crowdsource targets for input/feedback.

10. A system for crowdsourcing a project according to claim 8, wherein the input module is further configured to receive information using an AI tool to gather and aggregate information.

11. A system for crowdsourcing a project according to claim 8, wherein the crowd source module is further configured to determine a plurality of crowd source targets using an AI tool to analyze the information.

12. A system for crowdsourcing a project according to claim 8, wherein the crowd source module is further configured to contacte the plurality of crowd source targets and provide specific options for responding to the contact.

13. A system for crowdsourcing a project according to claim 8, wherein the project comprises determining a course stream in a learning management system.

14. A system for crowdsourcing a project according to claim 8, wherein the project comprises providing pre-requisites for a course in a learning management system.
